(19) United States
(12) Patent Application Publication
(10) Pub. No.: US 2014/0093785 A1
(43) Pub. Date: Apr. 3, 2014

(54) METHOD OF PRODUCING SOLID SULFIDE ELECTROLYTE MATERIAL AND SOLID SULFIDE ELECTROLYTE MATERIAL

(71) Applicants: Koichi Sugiura, Susono-shi (JP); Koji Kawamoto, Miyoshi-shi (JP); Takayuki Koyama, Susono-shi (JP)

(72) Inventors: Koichi Sugiura, Susono-shi (JP); Koji Kawamoto, Miyoshi-shi (JP); Takayuki Koyama, Susono-shi (JP)

(73) Assignee: TOYOTA JIDOSHA KABUSHIKI KAISHA, Toyota-shi, Aichi-ken (JP)

(21) Appl. No.: 14/117,784

(22) PCT Filed: May 11, 2012
(86) PCT No.: PCT/IB2012/000918

§ 371 Date: Nov. 14, 2013

(30) Foreign Application Priority Data
May 18, 2011 (JP) 2011-111062

(51) Int. Cl. H01M 10/056; H01M 10/052

(52) U.S. Cl. CPC H01M 10/056; H01M 10/052
USPC 429/315; 429/306; 429/317; 429/314

(57) ABSTRACT

The invention provides a method of producing a solid sulfide electrolyte material, with this method including a microparticulation step in which a sulfide glass containing Li, S, and P is mixed with an adhesive polymer and the sulfide glass is ground.

### BACKGROUND OF THE INVENTION

1. Field of the Invention

The invention relates to a method of producing a solid sulfide electrolyte material enabling to simultaneously to achieve a microparticulation of the solid sulfide electrolyte material, a high yield, and retention of the Li ion conductivity. The invention further relates to a solid sulfide electrolyte material.

2. Description of Related Art

The recent quite rapid dissemination of communication devices and information-related devices such as personal computers, video cameras, portable phones, and so forth has brought with it a strong focus on the development of the batteries that are used as power sources in these devices. The development is also underway in the automotive sector of high-output, high-capacity batteries for use in electric automobiles and hybrid automobiles. Among the various types of batteries, a great deal of attention is currently being directed to lithium batteries because lithium batteries offer a high energy density.

At the present time, the commercially available lithium batteries use a liquid electrolyte that contains a flammable organic solvent, and this has necessitated the installation of safety devices to inhibit temperature runaway during a short circuit and has also necessitated improvements from a structure/materials perspective in order to prevent short circuiting. In contrast to this, it is thought that a lithium battery that has been made into an all solid-state battery by replacing the liquid electrolyte with a solid electrolyte layer, because it would not use a flammable organic solvent in the battery, would support a simplification of the safety devices and would have excellent consequences for the production cost and productivity. Solid sulfide electrolyte materials are available as a solid electrolyte material for use in such a solid electrolyte layer.

The solid sulfide electrolyte material must be microparticulated in order to obtain a high-performance all solid-state battery. For example, a method of producing a solid sulfide electrolyte having an average particle diameter of 0.5 μm to 1.5 μm is disclosed in Japanese Patent Application Publication No. 2009-211950 (JP 2009-211950 A). In order to remove coarse particles having a large particle diameter, this method employs a procedure in which a Nutsche-type vacuum filtration is carried out using a mesh sheet or a procedure in which a slurry is stirred and the upper portion of the liquid is drawn off. However, a solid sulfide electrolyte material production method that employs such removal procedures requires substantial time and labor inputs and thus has a poor solid sulfide electrolyte material productivity. Moreover, when, for example, a dispersing agent, e.g., an amine salt or an amide having an aliphatic alkyl or aryl group, is used in order to improve the productivity, this ends up reducing the Li ion conductivity of the solid sulfide electrolyte material.

### SUMMARY OF THE INVENTION

The invention provides a high-productivity method of producing a solid sulfide electrolyte material that can easily perform microparticulation of the solid sulfide electrolyte material and can produce a solid sulfide electrolyte material having an excellent Li ion conductivity. The invention also provides a solid sulfide electrolyte material.

A first aspect of the invention relates to a method of producing a solid sulfide electrolyte material, wherein an adhesive polymer is mixed with a sulfide glass that contains Li, S, and P and the sulfide glass is ground.

The use in accordance with the invention of an adhesive polymer as a dispersing agent can prevent the sulfide glass from undergoing the granulation and sticking to the container that are produced when a sulfide glass is ground, and as a consequence makes it possible to easily carry out microparticulation of the solid sulfide electrolyte material and to recover the microparticulated solid sulfide electrolyte material at high yields. In addition, the Li ion conductivity of the sulfide glass can be retained post-grinding due to the use of an adhesive polymer, and a solid sulfide electrolyte material that exhibits an excellent Li ion conductivity can thus be obtained.

The main chain of the adhesive polymer may contain an unsaturated hydrocarbon backbone.

The adhesive polymer preferably may have an adhesive functional group as a terminal functional group and this adhesive functional group preferably hay have at least one of O, N, and double bonds.

A solvent is preferably additionally mixed into the sulfide glass and adhesive polymer mixture during grinding of the sulfide glass. This is done because sticking by the sulfide glass to the container can be prevented by carrying out a wet grinding using a solvent.

The sulfide glass may contain at least one of F, Cl, Br, I, and O.

A second aspect of the invention relates to a solid sulfide electrolyte material that contains an adhesive polymer and a sulfide glass containing Li, S, and P wherein an average particle diameter of the sulfide glass is in a range from 0.1 μm to 5 μm.

Since in accordance with the invention this is a sulfide glass having a specific average particle diameter, for example, a high-capacity, high-output all solid-state battery can be obtained when this sulfide glass is used in an all solid-state battery.

The microparticulation of the solid sulfide electrolyte material can thus be carried out easily and at high productivities with the production of a solid sulfide electrolyte material that has an excellent Li ion conductivity.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flow chart that shows an example of an embodiment of the method according to the invention for producing a solid sulfide electrolyte material;

FIG. 2 is a scanning electron microscope (SEM) image of the solid sulfide electrolyte material obtained in Example 1;

FIG. 3 is an SEM image of the solid sulfide electrolyte material obtained in. Example 4;

FIG. 4 is an SEM image of the solid sulfide electrolyte material obtained in Comparative Example 1; and

FIG. 5 is an SEM image of the solid sulfide electrolyte material obtained in Comparative Example 3.

### DETAILED DESCRIPTION OF EMBODIMENTS

The method of producing a solid sulfide electrolyte material according to embodiments of the invention and the solid sulfide electrolyte material according to embodiments of the invention are described in detail in the following.

A. The method of Producing a Solid Sulfide Electrolyte Material

The method of producing a solid sulfide electrolyte material according to an embodiment of the invention has a microparticulation step in which a sulfide glass containing Li, S, and P is mixed with an adhesive polymer and the sulfide glass is ground.

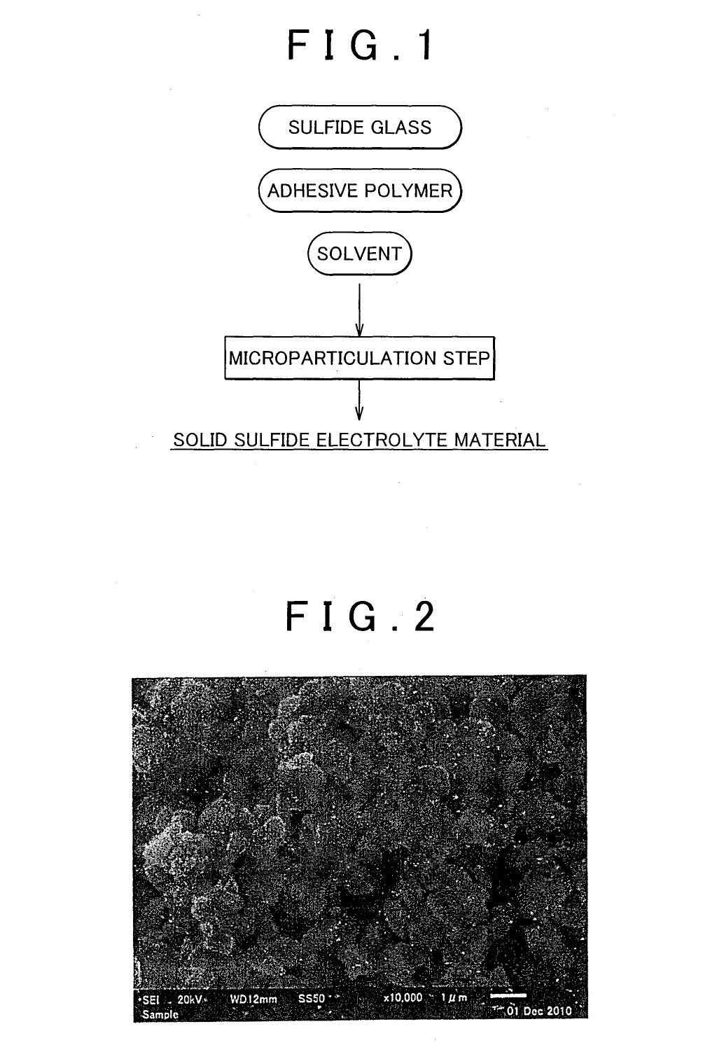

FIG. 1 is a flow chart that shows an example of the method of producing a solid sulfide electrolyte material. According to FIG. 1, a sulfide glass containing Li, S, and P (for example, 70Li₂S—30P₂S₅ glass), an adhesive polymer (for example, a butylene rubber having the amino group as a terminal functional group), and a solvent (for example, dehydrated heptane) are first prepared and these are then introduced into a zirconia pot and zirconia balls are additionally introduced and the pot is sealed. This pot is subsequently installed in a planetary ball mill and mechanical milling is performed under prescribed conditions in order to grind the sulfide glass (microparticulation step). This results in the production of a microparticulated solid sulfide electrolyte material. The terminal functional group may be at the terminal of a side chain or at the terminal of the main chain, wherein the former is preferred.

According to an embodiment of the invention, the use of the adhesive polymer as a dispersing agent can prevent the sulfide glass from undergoing the granulation and sticking to the container that are produced when a sulfide glass is ground. As a consequence, microparticulation of the solid sulfide electrolyte material can be carried out easily and the microparticulated solid sulfide electrolyte material can be recovered at high yields. Since the amorphous sulfide glasses are soft materials and readily form a solid/solid interface, their use as a solid electrolyte material in an all solid-state battery has been expected. However, because sulfide glasses are soft, the application of mechanical energy to the particles produces sticking to the container, which makes collection and recovery highly problematic; in addition, the particles undergo granulation with each other, making it difficult to carry out microparticulation at a high yield of the particles as such. In contrast to this, steric hindrance can be generated between the sulfide glass particles through the use of the adhesive polymer according to the embodiments of the invention, and this can prevent granulation and sticking to the container during grinding and thus makes it possible to combine a high recovery with microparticulation of the sulfide glass. The use of the adhesive polymer as a dispersing agent also makes possible retention of the Li ion conductivity of the sulfide glass post-grinding and production of a solid sulfide electrolyte material that exhibits an excellent Li ion conductivity. The adhesive polymer additionally offers the advantage of being able to function as a binder in a subsequent step.

1. The Microparticulation Step

In the microparticulation step in an embodiment of the invention, an adhesive polymer is mixed with a sulfide glass containing Li, S, and P and the sulfide glass is ground.

The sulfide glass in the embodiments of the invention contains Li, S, and P. This “sulfide glass” refers to an amorphous solid sulfide electrolyte material synthesized by the amorphization of a starting composition, and denotes not only a rigorously “amorphous” state in which a crystalline periodicity is not seen in, for example, X-ray diffraction measurements, but also denotes solid sulfide electrolyte materials synthesized by amorphization, e.g., by mechanical milling, in general.

The sulfide glass contains Li, S, and P, and Li, S, and P are generally made the main component. This “main component” means that the total content of the Li, S, and P in the sulfide glass is at least 50 mol %, wherein at least 60 mol % is preferred. and at least 70 mol % is more preferred.

There are no particular limitations on the sulfide glass other than that Li, S, and P are made the main component, and the sulfide glass may even contain only Li, S, and P. The sulfide glass may contain at least one selection from F, Cl, Br, I, and O.

The Li ion conductivity of the sulfide glass can be enhanced by the presence of the halogen. The presence of the O can cleave sulfur bridges present in the sulfide glass and can bring about a small hydrogen sulfide yield.

The sulfide glass is preferably a sulfide glass prepared using a starting composition containing Li₂S and a sulfide of P. This starting composition may also contain at least one selection from F-containing compounds, Cl-containing compounds, Br-containing compounds, I-containing compounds, and O-containing compounds.

The Li₂S present in the starting composition preferably contains little impurity because a low impurity level can prevent secondary reactions. The Li₂S synthesis method can be exemplified by the method described in Japanese Patent Application Publication No. 7-330312 (JP 7-330312 A). The Li₂S is preferably purified using, for example, the method described in WO 2005/040039. The sulfide of P present in the starting composition can be exemplified by P₂S₃, P₂S₅, and so forth.

The F-containing compound that may be present in the starting composition should contain fluorine, but is not otherwise particularly limited and can be exemplified by LiF, LiPF₆, and so forth. The Cl-containing compound that may be present in the starting composition should contain chlorine, but is not otherwise particularly limited and can be exemplified by LiCl and so forth. The Br-containing compound that may be present in the starting composition should contain bromine, but is not otherwise particularly limited and can be exemplified by LiBr and so forth. The I-containing compound that may be present in the starting composition should contain iodine, but is not otherwise particularly limited and can be exemplified by LiI and so forth. The O-containing compound that may be present in the starting composition should be able to cleave the bonds in sulfur bridges present in the sulfide glass, but is not otherwise particularly limited and can be exemplified by Li₂O, Li₂O₂, Na₂O, K₂O, MgO, CaO, and so forth, whereamong Li₂O is preferred. Li₂O is preferred because the O in Li₂O can very efficiently cleave the sulfur bridges present in sulfide glass. In addition, Li₂O added in excess offers the advantage that, even when present unreacted, it does not generate hydrogen sulfide. Moreover, since Li₂O contains Li, it can bring about an improvement in the Li ion conductivity of the sulfide glass yielded by cleavage of the sulfur bridges.

The sulfide glass preferably substantially does not contain Li₂S because this enables the preparation of a sulfide glass that generates little hydrogen sulfide. Hydrogen sulfide is generated by the reaction of Li₂S with water. For example, Li₂S tends to remain present when the starting composition contains a large proportion of Li₂S. This “substantially does not contain Li₂S” can be confirmed by X-ray diffraction. In specific terms, the determination can be made that Li₂S is substantially not present when the peaks for Li₂S (2 θ=27.0°, 31.2°, 44.8°, and 53.1°) are not present.

The sulfide glass also preferably substantially does not contain sulfur bridges because this enables the preparation of a sulfide glass that generates little hydrogen sulfide. A “sulfur bridge” refers to a sulfur bridge in a compound produced by the reaction of Li₂S and a sulfide of phosphorus. An applicable example in this regard is the sulfur bridge with the S₃P—S—PS₃ structure that is formed by the reaction of Li₂S and P₂S₅. This bridging sulfur readily reacts with water to readily form hydrogen sulfide. The “substantially does not contain sulfur bridges” can be checked by measurement of the Raman scattering spectrum. For example, in the case of a sulfide glass in the Li₂S—P₂S₅ system, the peak for the S₃P—S—PS₃ structure generally appears at 402 cm⁻¹. As a consequence, this peak is preferably not detected. The peak for the PS₄³⁻ structure generally appears at 417 cm⁻¹. The intensity I₄₀₂ at 402 cm⁻¹ is preferably less than the intensity I₄₁₇ at 417 cm⁻¹. More specifically, the intensity I₄₀₂ is, for example, preferably not more than 70%, more preferably not more than 50%, and even, more preferably not more than 35% of the intensity 1₄₁₇. For sulfide glasses outside the Li₂S—P₂S₅ system, the sulfur bridge-containing unit can be identified and the substantial absence of sulfur bridges can then be determined by measurement of the peak for this unit.

When the sulfide glass under consideration substantially does not contain Li₂S and substantially does not contain sulfur bridges, the sulfide glass generally has the ortho composition or nearly the ortho composition. At a general level, ortho refers to the oxo acid have the highest degree of hydration among the oxo acids yielded by hydration of the same oxide. In an embodiment of the invention, the ortho composition refers to the crystalline composition to which the most Li₂S has added among sulfides. For example, Li₃PS₄ corresponds to the ortho composition for the Li₂S—P₂S₅ system. When the sulfide glass contains O, a portion of the S in the ortho composition is replaced by O.

For example, in the case of sulfide glass in the Li₂S—P₂S₅ system, the proportions of Li₂S and P₂S₅ that give the ortho composition are Li₂S:P₂S₅=75:25 on a molar basis. When the starting composition contains Li₂S and P₂S₅, the proportion of Li₂S with reference to the sum of the Li₂S and P₂S₅ is preferably in the range from 70 mol % to 80 mol %, more preferably in the range from 72 mol % to 78 mol %, and even more preferably in the range from 74 mol % to 76 mol %.

In the case, for example, of sulfide glass in the Li₂S—Li₂O—P₂S₅ system, the proportions of Li₂S, Li₂O, and P₂S₅ that give the ortho composition are (Li₂S+Li₂O):P₂S₅=75:25 on a molar basis. When the starting composition contains Li₂S, Li₂O, and P₂5₅, the proportion of the Li₂S and Li₂O with reference to the sum of the Li₂S, Li₂O, and P₂S₅ is preferably in the range from 70 mol % to 80 mol %, more preferably in the range from 72 mol % to 78 mol %, and even more preferably in the range from 74 mol % to 76 mol %. The proportion of Li₂O with reference to the sum of the Li₂S and Li₂O is, for example, preferably in the range from 1.3 mol % to 33.3 mol % and more preferably in the range from 4.0 mol % to 20.0 mol %. The reasons are as follows: a substantial increase in hydrogen sulfide generation can occur when the Li₂O proportion is too small; a substantial decline in the Li ion conductivity can occur when the Li₂O proportion is to large. The Li₂O proportion with reference to the sum of the Li₂S, Li₂O, and P₂S₅ is, for example, preferably in the range from 1 mol % to 25 mol % and more preferably in the range from 3 mol % to 15 mol %.

When the sulfide glass in an embodiment of the invention is a sulfide glass prepared using a starting composition that contains LiX (X=F, Cl, Br, I), the proportion of the LiX, for example, is preferably in the range from 1 mol % to 60 mol %, more preferably in the range from 5 mol % to 50 mol %, and even more preferably in the range from 10 mol % to 40 mol %. The X here is preferably at least one selection from Cl, Br, and I because this can bring about a greater improvement in the Li ion conductivity of the sulfide glass.

The shape of the sulfide glass prior to the microparticulation step can be, for example, particulate. The average particle diameter (D₅₀) of the particulate sulfide glass is, for example, preferably in the range from 10 μm to 60 μm and more preferably in the range from 20 μm to 40 μm. This average particle diameter can be determined, for example, using a particle size distribution analyzer. The sulfide glass preferably has a high Li ion conductivity, and the Li ion conductivity at normal temperature is, for example, preferably at least 1×10⁻⁴ S/cm and more preferably is at least 1×10⁻³ S/cm.

The method of producing the sulfide glass prior to the microparticulation step should be a method that can produce a sulfide glass as has been described in the preceding, but is not otherwise particularly limited. An example is a production method that has a synthesis step in which the starting composition as described above is subjected to amorphization. The amorphization process can be exemplified by mechanical milling and a melting/quenching process. Mechanical milling is preferred therebetween because mechanical milling can be carried out at normal temperature and supports a simplification of the production process.

The adhesive polymer in an embodiment of the invention will now be described. The adhesive polymer should be a polymer that exhibits adhesiveness for the sulfide glass but is not otherwise particularly limited. Here, polymer refers to a polymer having a weight-average molecular weight (M_{w}) of at least 10,000. The weight-average molecular weight of the adhesive polymer is preferably in the range from 50,000 to 500,000 and more preferably is in the range from 100,000 to 300,000. The weight-average molecular weight can be determined as the value as polystyrene by measurement by gel permeation chromatography (GPC).

The main chain of the adhesive polymer preferably contains an unsaturated hydrocarbon backbone. The unsaturated hydrocarbon backbone can be exemplified by a hydrocarbon backbone that contains the carbon-carbon double bond. The main chain of the adhesive polymer can be, for example, a hydrocarbon chain. The adhesive polymer can exhibit adhesiveness based on physical adhesion or can exhibit adhesiveness based on chemical adhesion, wherein the latter is preferred because it can readily produce steric hindrance between the sulfide glass particles. An example of chemical adhesion is adhesion that utilizes hydrogen bonding.

An adhesive polymer that exhibits adhesiveness based on chemical adhesion generally has an adhesive functional group as a terminal functional group. This “adhesive functional group” denotes a functional group capable of chemically bonding with the sulfide glass. This adhesive polymer can be exemplified by butylene rubbers that have an adhesive functional group, ethylene rubbers that have an adhesive functional group, propylene rubbers that have an adhesive functional group, polyvinyl alcohols that have an adhesive functional group, and styrene-butadiene rubbers that have an adhesive functional group, among which butylene rubbers that have an adhesive functional group, ethylene rubbers that have an adhesive functional group, and propylene rubbers that have an adhesive functional group are preferred and butylene rubbers that have an adhesive functional group are particularly preferred. The reason for this is the low reactivity with the sulfide glass and ease of retention of the Li ion conductivity. Butylene rubber has a butylene backbone for a portion of the main chain (for example, a hydrocarbon chain); ethylene rubber has an ethylene backbone for a portion of the main chain (for example, a hydrocarbon chain); and propylene rubber has a propylene backbone for a portion of the main chain (for example, a hydrocarbon chain).

The adhesive functional group under consideration preferably has at least one selection from O, N, and double bonds. Such an adhesive functional group can be exemplified by the hydroxyl group, amide group, cyano group, carboxyl group, sulfonic acid group, epoxy group, and amino group. The adhesive functional group content in the adhesive polymer is, for example, preferably in the range from 1×10⁻⁵ weight % to 1×10⁻³ weight % and more preferably in the range from 1×10⁻⁴ weight % to 5×10⁻⁴ weight %.

The adhesive polymer is introduced in an amount that is preferably in the range from 0.01 weight % to 10 weight % with reference to the sulfide glass and more preferably in the range from 1 weight % to 5 weight % with reference to the sulfide glass. The reasons for this are as follows: when too little adhesive polymer is introduced, it may not be able to exhibit a satisfactory performance as a dispersing agent; when too much adhesive polymer is introduced, a high viscosity is generated and this can drastically impair the grinding efficiency.

A solvent is also preferably admixed in the microparticulation step. The execution of a wet grinding using a solvent can prevent sticking by the sulfide glass to the container and can prevent granulation of the sulfide glass particles. This solvent should not degrade the sulfide glass or adhesive polymer, but is not otherwise particularly limited and can be exemplified by heptane, hexane, octane, toluene, benzene, and xylene. The solvent preferably has a low water content in order to avoid the generation of hydrogen sulfide.

The sulfide glass is ground in the microparticulation step. The method of grinding the sulfide glass should be able to conduct microparticulation to give sulfide glass with a desired size, but is not otherwise particularly limited and can be exemplified by jet milling and media-based grinding, e.g., bead mills, planetary ball mills, and so forth. Planetary ball mills are preferred among the preceding. The grinding conditions are set so as to make possible grinding of the sulfide glass to a desired particle diameter. For example, when a planetary ball mill is used, the sulfide glass, adhesive polymer, solvent, and grinding balls are added and treatment is carried out for a prescribed time at a prescribed revolution rate. The ball diameter (φ) of the grinding balls is, for example, preferably in the range from 0.2 mm to 2 mm and more preferably in the range from 0.6 mm to 1 mm. The reasons for this are as follows: when the ball diameter is too small, the grinding balls are then difficult to handle and they can be a source of contamination; when the ball diameter is too large, it can be very difficult to grind the sulfide glass to the desired particle diameter. The table revolution rate during planetary ball milling is, for example, preferably in the range from 100 rpm to 400 rpm and more preferably in the range from 150 rpm to 300 rpm. The planetary ball milling treatment time is, for example, preferably in the range from 0.5 hour to 5 hours and more preferably in the range from 1 hour to 4 hours.

Due to the use of the adhesive polymer during grinding of the sulfide glass, the adhesive polymer functions as a dispersing agent for the sulfide glass and can prevent granulation of the sulfide glass and sticking by the sulfide glass. As a result, the sulfide glass that has been ground in the microparticulation step can be recovered at high yields. The yield of the sulfide glass is, for example, preferably at least 90% and more preferably at least 95%. This yield can be calculated using (amount of sulfide glass collected after the microparticulation step)/(amount of sulfide glass introduced in the microparticulation step).

2. The Solid Sulfide Electrolyte Material

The solid sulfide electrolyte material obtained according to an embodiment of the invention is prepared by grinding the sulfide glass and contains the adhesive polymer. The use of the microparticulated sulfide glass for the solid sulfide electrolyte material supports a reduction in the film thickness of the solid electrolyte layer, an increase in the packing fraction for the solid electrolyte layer and the electrode active material layer, and the formation of an excellent contact interface between the active material and the solid sulfide electrolyte material and thus makes it possible to obtain a high-capacity, high-output all solid-state battery. Moreover, because the solid sulfide electrolyte material contains an adhesive polymer, a solid electrolyte layer or electrode active material layer can be formed in ensuing steps either without the separate use of a binder or using a lower amount of binder, and a reduction in the Li ion conductivity can thus be suppressed. The average particle diameter (D₅₀) of the solid sulfide electrolyte material should be smaller than that of the sulfide glass prior to the grinding in the microparticulation step, but is not otherwise particularly limited and can be exemplified by preferably the range from 0.1 μm to 5 μm and more preferably the range from 0.5 μm to 4 μm. This average particle diameter can be determined, for example, using a particle size distribution analyzer. The solid sulfide electrolyte material preferably has a high Li ion conductivity, which, for example, is preferably at least 50% and more preferably at least 70% of the Li ion conductivity of the sulfide glass prior to the microparticulation step.

The solid sulfide electrolyte material can be used in any application that requires Li ion conductivity. Within this sphere, this solid sulfide electrolyte material is preferably used in an all solid-state battery. When this solid sulfide electrolyte material is used in an all solid-state battery, it may be used in the positive electrode active material layer, in the negative electrode active material layer, and/or in the solid electrolyte layer. In addition, the solid sulfide electrolyte material (sulfide glass) obtained by the previously described microparticulation step may be made into a crystallized sulfide glass by subjecting this solid sulfide electrolyte material to a heat treatment at a temperature that is equal to or greater than the crystallization temperature.

B. The Solid Sulfide Electrolyte Material

The solid sulfide electrolyte material according to embodiments of the invention is described in the following. The solid sulfide electrolyte material contains adhesive polymer and sulfide glass containing Li, S, and P wherein the average particle diameter of the sulfide glass is in the range from 0.1 μm to 5 μm.

Because this sulfide glass has the prescribed average particle diameter, for example, a high-capacity, high-output all solid-state battery can be obtained when this sulfide glass is used in an all solid-state battery.

The solid sulfide electrolyte material of an embodiment of the invention contains an adhesive polymer and a sulfide glass that contains Li, S, and P. Since the sulfide glass is soft, an excellent contact interface between the active material and the solid sulfide electrolyte material can be formed by having the solid sulfide electrolyte material contain the sulfide glass. The adhesive polymer and the composition of the sulfide glass are the same as described above in “A. The method of producing a solid sulfide electrolyte material” and their description at this point is therefore omitted.

The average particle diameter of the sulfide glass in the solid sulfide electrolyte material according to an embodiment of the invention is in the range from 0.1 μm to 5 μm. A reduction in the film thickness of the solid electrolyte layer and an increase in the packing fraction for the solid electrolyte layer and the electrode active material layer can be achieved by having the average particle diameter of the sulfide glass be within the prescribed range. This average particle diameter can be measured using, for example, a particle size distribution analyzer.

The adhesive polymer is preferably dispersed on the surface of the sulfide glass in the solid sulfide electrolyte material, and dispersion at the nanometer level is more preferred. This avoids impairing the Li ion conductivity. The solid sulfide electrolyte material can be obtained, for example, by the method described above in “A. The method of producing a solid sulfide electrolyte material”.

The invention is not limited to the embodiments described above. The embodiments described above are examples, and any embodiment that has substantially the same structure as the technical idea of the invention and accomplishes the same functional effects as the technical idea of the invention is encompassed by the technical scope of the invention.

The invention is more specifically described by the examples given below.

### Production Example

### Sulfide Glass Synthesis

Lithium sulfide (Li₂S, from Nippon Chemical Industries Co., Ltd., purity=99.9%) and phosphorus pentasulfide (P₂S₅, from Aldrich, purity=99.9%) were used as the starting materials. Their powders were weighed out in a glove box under an argon atmosphere (dew point=−70° C.) to provide an Li₂S:P₂S₅ molar ratio=70:30 and were mixed with an agate mortar to obtain the starting composition. 100 g of the obtained starting composition was introduced into a 500-mL ZrO₂ pot; ZrO₂ balls were introduced; and the pot was completely sealed (Ar atmosphere). This pot was installed in a planetary ball mill (P5 from Fritsch Japan Co., Ltd.) and dry mechanical milling was performed for 20 hours at a table revolution rate of 300 rpm to obtain a sulfide glass (70Li₂S—30P₂S₅ glass).

### Example 1

### The Microparticulation Step

1 g of the sulfide glass obtained in the Production Example, 40 g ZrO₂ balls (φ1 mm), 10 g dehydrated heptane (Kanto Chemical Co., Inc.) as solvent, and 0.014 g butylene rubber (from the JSR Corporation) having the amino group as a terminal functional group and added as the adhesive polymer, were introduced into a 45-mL ZrO₂ pot and the pot was completely sealed (Ar atmosphere). This pot was installed in a planetary ball mill (P7 from Fritsch Japan Co., Ltd.) and wet mechanical milling was performed for 6 hours at a table revolution rate of 200 rpm to grind the sulfide glass and produce a solid sulfide electrolyte material.

### Example 2

### The Microparticulation Step

10 g of the sulfide glass obtained in the Production Example, 100 g ZrO₂ balls (φ1 mm), 100 g dehydrated heptane (Kanto Chemical Co., Inc.) as solvent, and 0.14 g of the butylene rubber used in Example 1 and added as the adhesive polymer, were introduced into a 500-mL ZrO₂ pot and the pot was completely sealed (Ar atmosphere). This pot was installed in a planetary ball mill (P5 from Fritsch Japan Co., Ltd.) and wet mechanical milling was performed for 3 hours at a table revolution rate of 100 rpm to grind the sulfide glass and produce a solid sulfide electrolyte material.

### Example 3

### The Microparticulation Step

1 g of the sulfide glass obtained in the Production Example, 10 g ZrO₂ balls (φ0.6 mm), 10 g dehydrated heptane (Kanto Chemical Co., Inc.) as solvent, and 0.02 g of the butylene rubber used in Example 1 and added as the adhesive polymer, were introduced into a 500-mL ZrO₂ pot and the pot was completely sealed (Ar atmosphere). This pot was installed in a planetary ball mill (P5 from Fritsch Japan Co., Ltd.) and wet mechanical milling was performed for 4 hours at a table revolution rate of 200 rpm to grind the sulfide glass and produce a solid sulfide electrolyte material.

### Example 4

### The Microparticulation Step

2 g of the sulfide glass obtained in the Production Example, 40 g ZrO₂ balls (φ1 mm), 10 g dehydrated heptane (Kanto Chemical Co., Inc.) as solvent, and 0.028 g of the butylene rubber used in Example 1 and added as the adhesive polymer, were introduced into a 45-mL ZrO₂ pot and the pot was completely sealed (Ar atmosphere). This pot was installed in a planetary ball mill (P7 from Fritsch Japan Co., Ltd.) and wet mechanical milling was performed for 1 hour at a table revolution rate of 300 rpm to grind the sulfide glass and produce a solid sulfide electrolyte material.

### Comparative Example 1

### The Microparticulation Step

1 g of the sulfide glass obtained in the Production Example, 40 g ZrO₂ balls (φ1 mm), and 10 g dehydrated heptane (Kanto Chemical Co., Inc.) as solvent were introduced into a 45-mL ZrO₂ pot and the pot was completely sealed (Ar atmosphere). This pot was installed in a planetary ball mill (P7 from Fritsch Japan Co., Ltd.) and wet mechanical milling was performed for 1 hour at a table revolution rate of 300 rpm to grind the sulfide glass and produce a solid sulfide electrolyte material.

### Comparative Example 2

### The Microparticulation Step

1 g of the sulfide glass obtained in the Production Example, 40 g ZrO₂ balls (φmm), and 10 g dehydrated toluene (Kanto Chemical Co., Inc.) as solvent were introduced into a 45-mL ZrO₂ pot and the pot was completely sealed (Ar atmosphere). This pot was installed in a planetary ball mill (P7 from Fritsch Japan Co., Ltd.) and wet mechanical milling was performed for 1 hour at a table revolution rate of 300 rpm to grind the sulfide glass and produce a solid sulfide electrolyte material.

### Comparative Example 3

### The Microparticulation Step

10 g of the sulfide glass obtained in the Production Example, 100 g ZrO₂ balls (φ1 mm), 100 g dehydrated heptane (Kanto Chemical Co., Inc.) as solvent, and 0.1 g 2-ethylhexanol (Mitsubishi Chemical Corporation) as dispersing agent were introduced into a 500-mL ZrO₂ pot and the pot was completely sealed (Ar atmosphere). This pot was installed in a planetary ball mill (P5 from Fritsch Japan Co., Ltd.) and wet mechanical milling was performed for 5 hours at a table revolution rate of 800 rpm to grind the sulfide glass and produce a solid sulfide electrolyte material.

### Evaluations

### (SEM Observations)

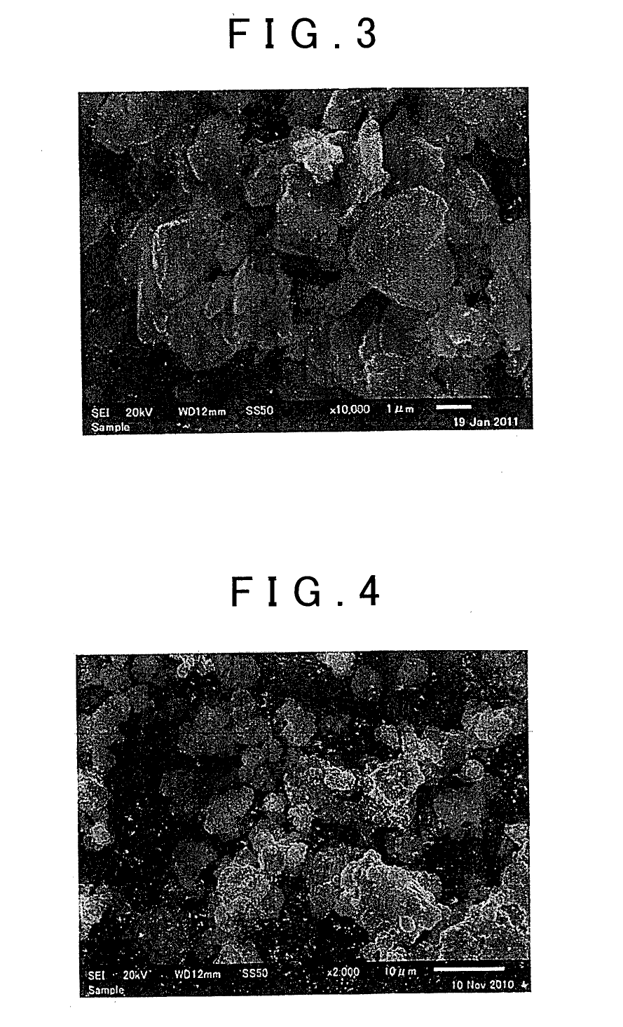

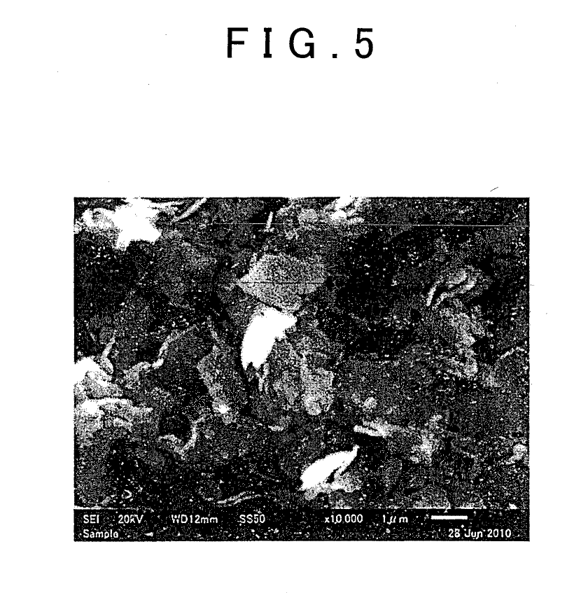

The solid sulfide electrolyte materials obtained in Examples 1 to 4 and Comparative Examples 1 to 3 were examined with an SEM. SEM images of the solid sulfide electrolyte materials obtained in Example 1, Example 4, Comparative Example 1, and Comparative Example 3 are shown in FIGS. 2 to 5, respectively. As shown in FIGS. 2 and 3, particles with a particle diameter of 5 μm and below were confirmed for the entire mass for the solid sulfide electrolyte materials obtained in Examples 1 and 4. The same was also true for Examples 2 and 3, although this has not been shown. In contrast to this, and as shown in FIG. 4, in the case of the solid sulfide electrolyte material obtained in Comparative Example 1, a large number of the particles had particle diameters of at least 5 μm and particles with particle diameters of about 10 μm were also seen. The same was also true for Comparative Example 2, although this has not been shown. On the other hand, as shown in FIG. 5, numerous particles with a particle diameter of 5 μm and below were observed for the solid sulfide electrolyte material obtained in Comparative Example 3.

### (Measurement of the Particle Size Distribution)

Small amounts of the solid sulfide electrolyte materials obtained in Examples 1 to 4 and Comparative Examples 1 to 3 and the sulfide glass obtained in the Production Example were taken as samples and submitted to measurement of the particle size distribution using a laser scattering/diffraction particle size distribution analyzer (Microtrac MT3300EXII from Nikkiso Co., Ltd.) and the average particle diameter (Dₛₒ) was determined. These results are given in Table 1.

### (Measurement of the Yield)

The yield was determined for the solid sulfide electrolyte materials obtained in Examples 1 to 4 and Comparative Examples 1 to 3. After the microparticulation step, the ZrO₂ balls were separated and the material adhering on the ZrO₂ balls was washed several times with heptane, after which the collected slurry was dried and the amount of solid sulfide electrolyte material (sulfide glass) collected was measured. The yield was calculated by dividing the collected amount of the obtained solid sulfide electrolyte material by the amount of sulfide glass introduced in the microparticulation step. These results are given in Table 1.

### (Measurement of the Li Ion Conductivity)

The Li ion conductivity was measured on the solid sulfide electrolyte materials obtained in Examples 1 to 4 and Comparative Examples 1 to 3 and on the sulfide glass obtained in the Production Example. For the solid sulfide electrolyte materials, the slurry collected as described above was dried for 30 minutes at 100° C. and the powder was collected, after which a 0.5 mm-thick 1 cm² pellet was prepared and molding at 4.3 tons was performed. For the sulfide glass, the powder was collected followed by preparation of a 0.5 mm-thick 1 cm² pellet and molding at 4.3 tons. The Li ion conductivity (normal temperature) was measured by the alternating-current impedance method on the pellet after molding. A Solartron 1260 was used for the measurement, and the measurement conditions were an applied voltage of 5 mV and a measurement frequency range of 0.01 MHz to 1 MHz. The resistance value at 100 kHz was read and corrected for thickness and converted to the Li ion conductivity. The results are given in Table 1.

TABLE 1

| | average | | Li ion |
|---|---|---|---|
| | particle diameter | yield | conductivity |
| | (μm) | (%) | (S/cm) |
| Example 1 | 1.4 | 92 | 7.0 × 10⁻⁴ |
| Example 2 | 3.4 | 95 | 7.1 × 10⁻⁴ |
| Example 3 | 0.8 | 91 | 7.4 × 10⁻⁴ |
| Example 4 | 4.6 | 99 | 8.6 × 10⁻⁴ |
| Comparative Example 1 | 7.2 | 2 | 8.1 × 10⁻⁴ |
| Comparative Example 2 | 5.9 | 70 | 6.4 × 10⁻⁴ |
| Comparative Example 3 | 2.1 | 98 | 4.2 × 10⁻⁵ |
| Production Example | 30 | — | 1.0 × 10⁻³ |

As shown in Table 1, and considered relative to the sulfide glass of the Production Example, a solid sulfide electrolyte material- having an average particle diameter of not more than 5 μm and a Li ion conductivity, of at least 7×10⁻⁴ S/cm was obtained at a high yield of at least 90% in each of Examples 1 to 4. These results demonstrated that microparticulation of the solid sulfide electrolyte material, a high yield, and retention of the Li ion conductivity could be simultaneously achieved by the method of producing a solid sulfide electrolyte material according to the embodiments of the invention. On the other hand, these could not all be simultaneously achieved in Comparative Examples 1 to 3. In Comparative Example 1, the yield of the solid sulfide electrolyte material was very low because the sulfide glass adhered in the form of a gum to the ZrO₂ balls after the microparticulation step and a particulate was not obtained.

1. A production method for a solid sulfide electrolyte material, the method comprising:
mixing an adhesive polymer with a sulfide glass that contains Li, S, and P, and grinding the sulfide glass,
wherein a main chain of the adhesive polymer contains an unsaturated hydrocarbon backbone,
an amount of the adhesive polymer is from 1 weight % to 5 weight % with reference to the sulfide glass,
the sulfide glass contains at least one of F, Cl, Br, L and O, and
an average particle diameter of the sulfide glass is in a range from 0.5 μm to 4 μm.

2. (canceled)

3. The production method according to claim 1, wherein the adhesive polymer has an adhesive functional group as a terminal functional group and this adhesive functional group has at least one of O, N, and double bonds.

4. The production method according to claim 3, wherein the adhesive functional group is at least one of a hydroxyl group, amide group, cyano group, carboxyl group, sulfonic acid group, epoxy group, and amino group.

5. The production method according to claim 1, wherein the adhesive polymer exhibits chemical adhesiveness with the sulfide glass.

6. The production method according to claim 5, wherein the adhesive polymer is at least one of butylene rubbers that have an adhesive functional group, ethylene rubbers that have an adhesive functional group, propylene rubbers that have an adhesive functional group, polyvinyl alcohols that have an adhesive functional group, and styrene-butadiene rubbers that have an adhesive functional group.

7. The production method according to claim 6, wherein the adhesive polymer is at least one of butylene rubbers that have an adhesive functional group, ethylene rubbers that have an adhesive functional group, and propylene rubbers that have an adhesive functional group.

8. The production method according to claim 7, wherein the adhesive polymer is a butylene rubber that has an adhesive functional group.

9. The production method according to claim 3, wherein the adhesive functional group content in the adhesive polymer is from 1×10⁻⁵ weight % to 1×10⁻³ weight %.

10. The production method according to claim 9, wherein the adhesive functional group content in the adhesive polymer is from 1×10⁻⁴ weight % to 5×10⁻⁴ weight %.

11. (canceled)

12. (canceled)

13. The production method according to claim 1, wherein a weight-average molecular weight of the adhesive polymer is from 50,000 to 500,000 of the appropriate molecular weight unit.

14. The production method according to claim 13, wherein the weight-average molecular weight of the adhesive polymer is from 100,000 to 300,000 of the appropriate molecular weight unit.

15. The production method according to claim 1, wherein a solvent is additionally mixed into a sulfide glass and adhesive polymer mixture during grinding of the sulfide glass.

16. (canceled)

17. (canceled)

18. (canceled)

19. The solid sulfide electrolyte material produced by the production method according to claim 1, wherein the adhesive polymer is dispersed at a nanometer level on a surface of the sulfide glass.
